(19) United States
(12) Patent Application Publication
(10) Pub. No.: US 2010/0236353 A1
(43) Pub. Date: Sep. 23, 2010

(54) Steering Wheel and Method for Manufacturing a Steering Wheel

(75) Inventors: Jacques Valentine, Chire en Montreuil (FR); Michel Ricou, Lusinan (FR)

Correspondence Address: HARNESS, DICKEY & PIERCE, P.L.C., P.O. BOX 828, BLOOMFIELD HILLS, MI, 48303, US

(73) Assignee: AUTOLIV DEVELOPMENT AB, Vargarda (SE)

(21) Appl. No.: 12/086,683

(22) PCT Filed: Dec. 19, 2006
(86) PCT No.: PCT/EP2006/012231

§ 371 Date: Jun. 7, 2010

(30) Foreign Application Priority Data
Dec. 21, 2005 (DE) 10 2005 061 697.6

(51) Int. Cl. B62D 1/04; B23P 11/00

(52) U.S. Cl. 74/552; 29/525.01

(57) ABSTRACT

The invention relates to a steering wheel and to a method for producing a steering wheel having a dimensionally stable base body (10) that can be attached to a steering column of a motor vehicle and to which a plastic attachment (20) is attached. The plastic attachment (20) is embodied as a separate component that is mechanically attached to the base body (10) via fastening elements (31, 32, 33).

The invention relates to a steering wheel having a dimensionally stable base body that can be attached to a steering column of a motor vehicle and that has a handle area to which a plastic attachment is attached and furthermore relates to a method for producing a steering wheel.

Known from DE 28 17 284 A1 is a multi-part steering wheel for a motor vehicle in which a handle body, which is connected to a hub area for attaching to a longitudinal column, is produced from two elements that have a semi-circular cross-section and that are joined to one another. The two elements are joined in a form fit via clip elements. It is disadvantageous in this case that it is possible to feel the transition on the butt edge of the two elements and that the assembly of the handle body on the hub area is complex.

Known from US 2002/0062712 A1 is a method for producing a steering wheel in motor vehicles and a motor vehicle steering wheel in which a handle ring made of metal, which is connected to a hub via spokes, has an intermediate layer glued to it and is then covered with leather. Alternatively, it is provided that the intermediate layer is joined, in particular glued, to the leather in advance, and then the two-layer flexible material is glued to the handle ring of the steering wheel.

The goal when producing steering wheels is to reduce costs, both during production and during assembly, while satisfying strength requirements and retaining the necessary space for additional components. For this purpose it is necessary to provide a less complex design and a reduced number of parts. Such an embodiment is also helpful in terms of a design that can be disassembled and in terms of easier recycling.

In addition to the aforesaid steering wheels and production methods, known from the prior art is providing a base body, for instance made of magnesium or aluminum, having an exterior handle ring and spokes for attaching a hub, with a plastic foam or a plastic cover, the plastic cover preferably made of polyurethane, being molded directly onto the handle ring, for instance in that the handle ring is injected with the plastic. A second protective or decorative layer made of plastic or leather is wound around or glued over this polyurethane support layer. This method is energy intense and requires a good deal of manual work, so that the steering wheel becomes very expensive. Moreover, the polyurethane layer is difficult to remove from the base body so that recycling is difficult and expensive.

The object of the present invention is to provide a steering wheel and a method for producing a steering wheel that is less cost-intensive and that assures simpler disassembly and recyclability.

This object is inventively attained using a steering wheel having the features of claim 1 and using a method having the features of claim 11. Advantageous embodiments and refinements of the invention are described in the subordinate claims.

The inventive steering wheel, which is made of a dimensionally stable base body that can be attached to a steering column of a motor vehicle and that has a ring-shaped or ring-like handle area to which a plastic attachment is fastened, provides that the plastic attachment is embodied as a separate component that is mechanically attached to the base body using fastening elements and adds to the contour of the handle area to create a largely closed circular or oval cross-section. Easy assembly and easy disassembly, while separating the materials used, can be effected by mechanically securing a separate plastic attachment component that is preferably integral and largely supplements or completes the cross-sectional contour of the handle area. Because of this it is no longer necessary to place the base body into an injection mold and completely or partially inject it with a plastic material and then subsequently to provide another wrapping for providing pleasant haptics. In addition to integral embodiment of the plastic attachment, the latter can also comprise a plurality of individual parts; this is particularly indicated when the handle area is not embodied as a continuous ring or ring-like body. The contour of the handle area of the base body is preferably supplemented to create a circle or oval.

A receiving groove is provided in the plastic attachment for the base body in order to enable the most secure possible attachment of the plastic attachment to the base body. The receiving groove follows the contour of the base body or of the handle segment of the base body so that radial displacement of the plastic attachment is prevented by a form-fit attachment. The attachment of the plastic attachment via the fastening elements must then only ensure that a force opposing the insertion direction of the base body into the plastic attachment is absorbed. Alternatively, embodied on the plastic attachment are form-fit elements that engage in the base body and are received thereby. The cross-section of the base body can be U-shaped, so that the form-fit elements extend into the cross-section. A shoulder can be embodied on the plastic attachment and it can assure precise positioning relative to the base body.

The plastic attachment can be embodied semi-circular in cross-section so that simple assembly is possible for instance by placing the base body into the plastic attachment. Alternatively, the base body can have a cross-sectional shape that placing of the plastic attachment and a form-fit attachment enable.

The base body preferably has spokes that connect the exterior handle body to a hub. The base body can be embodied in a single piece. The plastic attachment is preferably attached to the spokes via the fastening elements. To this end, receiving devices can be integrally molded on the plastic attachment, in which receiving devices the fastening elements engage or which the fastening elements can wrap about so that the fastening elements attach the plastic attachment to the base body for instance via a clip connection.

The receiving devices can at least partially wrap around the spokes between the handle body and the hub so that it is also not possible to twist the plastic attachment in the circumferential direction when the base body is circular.

One refinement of the invention provides that a recess for receiving an assembly element is embodied in the plastic attachment. Given further covering or wrapping of the base body and the plastic attachment with a cushioned cover or a decorative cover made of a different material, this cover can be inserted into the recess and clamped therein using the assembly element, for instance an assembly ring. The corresponding cover blank is merely placed around the base body and the covering secured therein. The ends are inserted into the recess and then secured by inserting the assembly ring or the assembly element.

The base body can be cast or injection molded and can preferably comprise a metal material, in particular a light metal alloy or a light metal. The fastening elements are preferably embodied as form-fit elements configured as plastic caps or the like. Alternative to an integral embodiment of the receiving devices for the fastening elements, these can also be separately arranged on or attached to the plastic attachment. The plastic attachment does not completely enclose the base body, but rather a joint between the base body and the plastic attachment runs in a straight-line assembly direction so that an area of the base body remains uncovered by the plastic attachment. The inventive method for producing a steering wheel for motor vehicles joins a plastic attachment and a dimensionally stable base body via fastening elements on the handle area, in particular by joining by means of snap-in connections, securing being provided in particular at spokes that lead from a handle body to a steering wheel hub.

One refinement of the invention provides that after the plastic attachment has been attached to the base body, a cushioned or decorative cover is placed around the base body and the plastic attachment and is clamped in a recess in the plastic attachment.

Exemplary embodiments of the invention are explained in greater detail in the following using the attached figures.

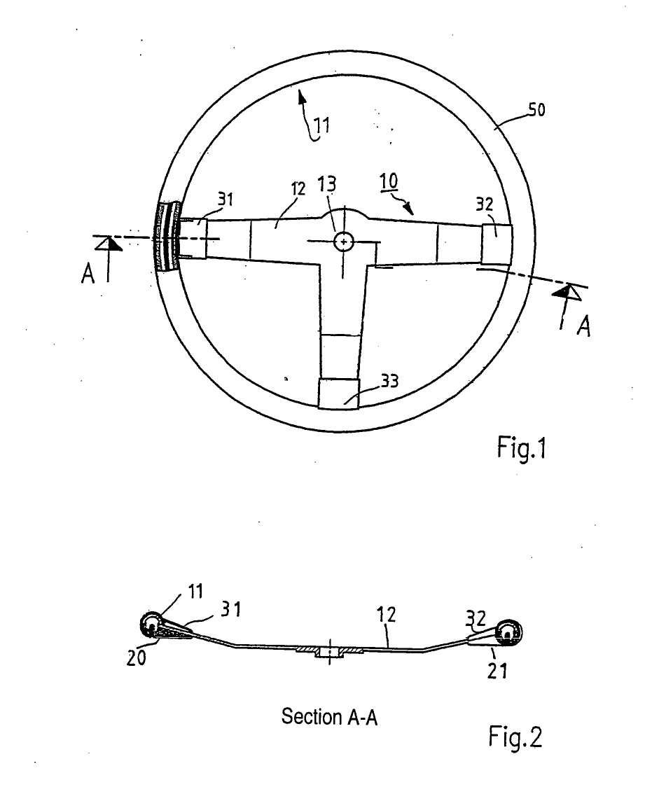

FIG. 1 is a partial drawing of a steering wheel;

FIG. 2 depicts a partially assembled steering wheel;

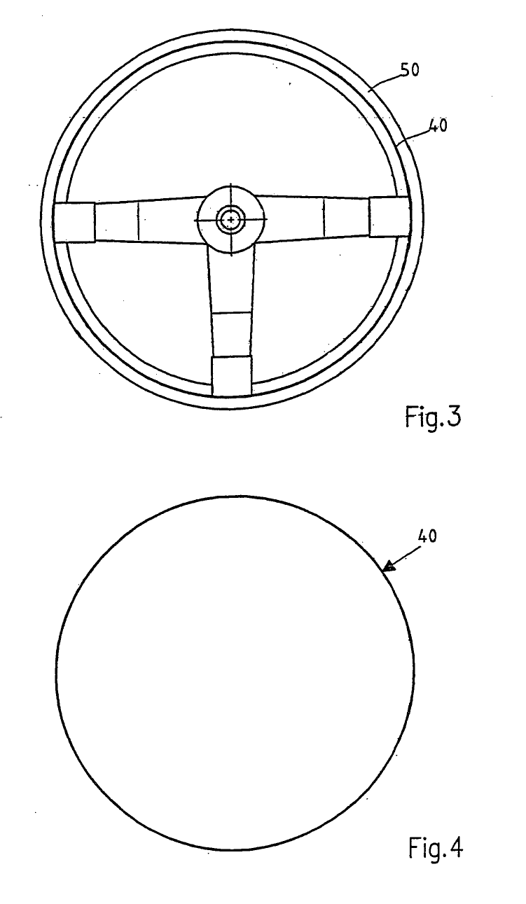

FIG. 3 depicts an assembled steering wheel without decorative cover;

FIGS. 4a and 4b depict a top view and a bottom view of a steering wheel having a decorative cover;

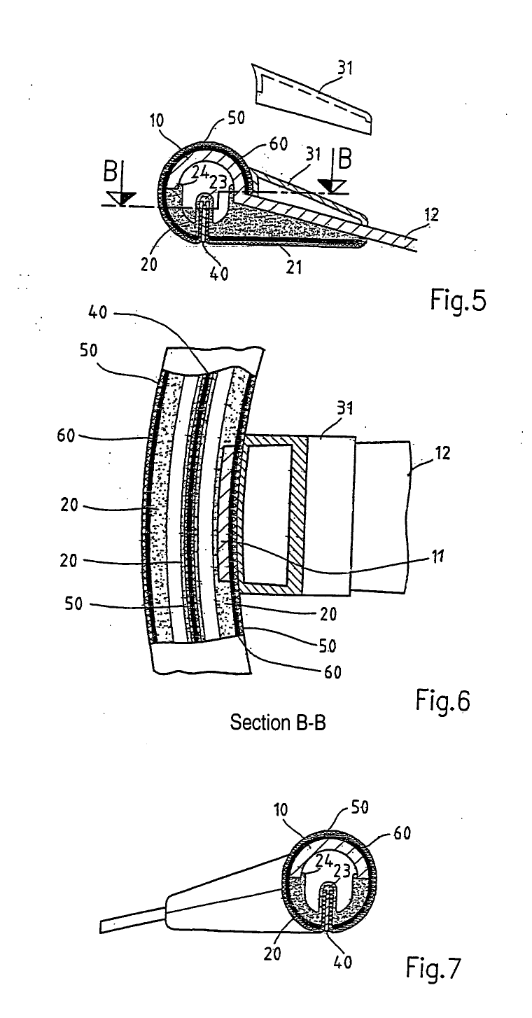

FIG. 5 is a section through a fully assembled steering wheel;

FIG. 6 is a section B-B through the steering wheel from FIG. 5; and,

FIG. 7 is an enlarged partial depiction of the right-hand segment of the steering wheel from FIG. 2.

FIG. 1 depicts a dimensionally stable base body 10 of a steering wheel made of a cast light metal alloy. The base body 10 has a ring-shaped handle area 11 and inwardly branching spokes 12 that connect the handle area 11 to a hub. The base body 10 is secured to a steering column (not shown) via this hub. Additional components such as impact absorber, airbag, operating elements, and the like can be mounted in the base body 10.

Arranged beneath the base body 10 is a plastic attachment 20 in the form of a separately produced plastic ring on which are provided inwardly projecting receiving devices 21 for the spokes 12. The receiving devices 21 are embodied such that the spokes 12 can be accommodated therein so that it is not possible to twist the plastic ring 20 about the base body 10 in the circumferential direction. The plastic attachment 20 is fastened via attached elements 31, 32, 33 that are embodied as separate plastic components in the form of plastic caps. The latter go around the spokes 12 and engage the receiving devices 21 so that the fastening elements 31, 32, 33 are attached in a form fit.

Furthermore shown is an assembly element 40 that can be inserted from below, that is, from the side of the plastic attachment 20 that opposes the base body 10, into a recess that is not shown in FIG. 1. A cushion or decorative cover that surrounds both the base body 10 and the plastic attachment 20 can be attached via the assembly element 40, which here is embodied as an assembly ring, to the components 10, 20 that are joined to one another.

FIG. 2 depicts a partially assembled steering wheel in which the base body 10 was already placed onto the plastic attachment 20 from above or corresponding form-fit elements of the plastic attachment 20 were received by the base body 10. The receiving devices 21 enclose the spokes 12. The plastic attachment 20 is aligned with the exterior radial circumference of the base body 10 or handle area 11 so that when assembled a closed, continuous cross-section without shoulders or perceptible joints results. The assembly ring 40 has not yet been inserted into the plastic attachment 20.

FIG. 3 depicts the conclusion of the assembly of the base body 10 on the plastic attachment 20, in which the plastic caps 31, 32, 33 enclose the spokes 12 and are clipped onto the receiving devices 21.

For final assembly, a cover 50 is placed around the base body 10 and the plastic attachment 20 around the handle area and possibly around the fastening elements 31, 32, 33 and inserted into a recess 23 provided in a side of the plastic attachment 20 that faces away from the driver. A cushioned layer 60 made of a foam may be provided under the decorative cover 50 in order to improve the haptics. After the cushioned layer 60 and the decorative leather or plastic cover 50 have been inserted into the recess 23, the assembly ring 40 is inserted into this recess 23 and the coverings are securely clamped. Inserting the assembly ring 40 simultaneously clamps the coverings through the layers 50, 60 about the base body 10 and the plastic attachment 20. The assembly ring 40 can be embodied of plastic or of a natural material, for instance leather. It is also possible to insert a leather strap into the recess 23.

FIG. 5 depicts the cross-sectional structure of a fully assembled steering wheel. The base body 10 and the plastic attachment 20 form a joint-less transition, whereby on the plastic attachment 20 [subject missing] having a semi-circular cross-section with projections 24 that project beyond the joint surface as form-fit elements and that radially fix the base body 10 on the plastic attachment 20. The projections 24 can exert a spring force so that the plastic attachment 20 can be securely clamped. The recess 23 is integrally embodied in the plastic attachment 20 and is oriented radially inward in a slit form. The components made of different materials can be easily assembled and disassembled using purely mechanical joining devices. The base body 10 provides the support structure for the other components and ensures adequate stability. The plastic attachment 20 adds to semi-circular cross-section of the base body 10, creating a largely closed circular or oval cross-section, the haptic requirements for a vehicle driver being satisfied by the cushioned layer 60 and the decorative layer 50, for instance made of a soft plastic or leather.

Disassembly is performed by removing the assembly element 40 from the recess 23, simply pulling off the layers 50, 60, and taking apart the metal base body 10 and the plastic attachment 20.

The decorative covering 50 can also be continued into the receiving devices 21 of the plastic attachment 20. Thus, provided in the receiving devices 21 is a recess into which a corresponding assembly element can be inserted. The recess then runs largely radially inward toward the hub.

FIG. 6 depicts a section in accordance with B-B in FIG. 5, and from this section it is easy to visualize the structure of the fully assembled steering wheel. The ring-shaped handle area 11, which is a part of the dimensionally stable base body 10, attaches to the base bodies with the spokes, which project radially outward. The fastening element 31 is attached in a mechanically stable manner, in particular is clipped in a form fit, to the spoke 12 and to the receiving device 21, which cannot be seen. At its handle area 11 and where necessary partially below the receiving devices 21 the base body 10 is covered with a cushioned layer 60, preferably made of foam, and a final decorative layer 50, for instance made of leather, these cushioned layers 50, 60 being securely clamped by the assembly ring 40, which is inserted in the recess 23 between the end areas of the cushioned layers 50, 60. The ring-shape of both the assembly element 40 and the handle area 11 is determined by the exemplary shape of the steering wheel; given other configurations, a different shape is provided and possible. Open cross-sections can also be created.

FIG. 7 is an enlarged partial depiction of the right-hand segment of FIG. 2. Here the semi-circular open design of both the base body 10 in the handle area and of the plastic attachment 20 can be plainly seen. As free space, the recess 23 is largely filled by the decorative cover 50 and the assembly ring 40. In the embodiment depicted, the cushioned cover 60 is not clamped in the recess 23 as an underlayer for the decorative cover 50, but this can be provided in an alternative embodiment. The projections 24, which are integral with the plastic attachment 20, clearly secure the plastic attachment 20 to the base body 10. In addition to the fastening elements 31, 32, 33, the plastic attachment 20 is held by the covers 50, 60, which are placed about the base body 10 and the plastic attachment 20 under tension and are clamped in the plastic attachment 20.

1-12. (canceled)

13. A steering wheel comprising:
a dimensionally stable base body for attachment to a steering column of a motor vehicle; and
a generally ring-shaped handle area; and
a plastic attachment is embodied as a separate component and mechanically attached to the base body with fastening elements, the plastic attachment adding contour of the handle area cross-section to define a largely closed circular or oval cross-section.

14. The steering wheel in accordance with claim 13, wherein the plastic attachment has a receiving groove or form-fit element for the base body.

15. The steering wheel in accordance with claim 13, wherein the plastic attachment is semi-circular.

16. The steering wheel in accordance with claim 13, wherein the base body has spokes connecting an exterior handle area to a hub and the plastic attachment is attached to the spokes.

17. The steering wheel in accordance with claim 13, wherein the plastic attachment defines a recess for receiving an assembly element.

18. The steering wheel in accordance with claim 17, wherein the base body and the plastic attachment are covered by a cover inserted in the recess and clamped therein by the assembly element.

19. The steering wheel in accordance with claim 13, wherein the base body is cast or injection molded.

20. The steering wheel in accordance with claim 13, wherein the base body is produced from a metal material.

21. The steering wheel in accordance with claim 20, wherein the metal material is selected from a group including a light metal and a light metal alloy.

22. The steering wheel in accordance with claim 13, wherein the fastening elements are plastic caps.

23. The steering wheel in accordance with claim 13, wherein the fastening elements engage the plastic attachment in receiving devices molded integrally thereon.

24. A method for producing a steering wheel for motor vehicles in which method a separately produced plastic attachment is attached to a handle area of a dimensionally stable base body via fastening elements.

25. The method in accordance with claim 24, comprising:
after the plastic attachment has been attached to the base body, placing a cover around the base body; and
clamping the plastic attachment into a recess in the plastic attachment.
